(19) United States
(12) Patent Application Publication
(10) Pub. No.: US 2004/0159544 A1
(43) Pub. Date: Aug. 19, 2004

(54) High temperature, carbon monoxide-tolerant perfluorosulfonic acid composite membranes and methods of making same

(76) Inventors: Andrew Bocarsly, Plainsboro, NJ (US); Kevork Adjemian, Prussia, PA (US); Seung Jae Lee, Seongnam City (KR)

Correspondence Address: Stuart H Nissim, Synnestvedt Lechner & Woodbridge, PO Box 592, Princeton, NJ, 08542-0592, US

(21) Appl. No.: 10/471,870

(22) PCT Filed: Mar. 14, 2002
(86) PCT No.: PCT/US02/07905

(51) Int. Cl. C25B 13/00; C25C 7/04; H01M 4/96; H01M 4/90; H01M 4/86; H01M 8/10

(52) U.S. Cl. 204/296; 521/27; 429/30; 429/33; 429/41

(57) ABSTRACT

PFSAs having CO tolerances greater than 500 ppm at temperatures above 100° C. are provided by decreasing the equivalent weight and thickness of the membrane and impregnating the membrane pores with an oxide, e.g., a hydrophilic siloxane polymer or TiO₂. This was accomplished by either impregnating an extruded PFSA film via sol-gel processing of tetraethoxysilane, or by preparing a recast film, using solubilized PFSA and an oxide source.

### CROSS REFERENCE TO RELATED APPLICATIONS

This application claims the priority of U.S. Provisional Patent Application Serial No. 60/275,656 filed on 14 Mar. 2001, the entire contents and subject matter of which is hereby incorporated in total by reference.

### BACKGROUND OF THE INVENTION

1. Field of the Invention

This invention relates to hydrogen/oxygen proton exchange membrane fuel cells, more particularly to high temperature, CO-tolerant composite PSFA membranes for use as proton exchange membranes.

2. Description of the Related Art

Recent advances have made hydrogen/oxygen proton-exchange membrane fuel cells (PEMFCs) a potential alternative to internal combustion and diesel engines for transportation. Cells of this type have also been suggested for stationary power generation. [1] These advances include the reduction of the platinum loading needed for electrocatalysis, and membranes with: high specific conductivity (0.1 ohm⁻¹ cm⁻¹), good water retention, and long lifetimes.

The advantages of PEMFCs over thermal engines are the ultra low or zero emissions of environmental pollutants (CO, NO, VOCs, and SOₓ), fewer moving parts and higher theoretical efficiencies for energy conversion. PEMFCs perform optimally with pure H₂ and O₂ as the reactant gases. Unfortunately, the storage, transportation, and refueling of H₂ gas is nontrivial, particularly for the transportation application. However, hydrogen for transportation can be produced by on-board fuel processing of liquid hydrocarbons or alcohols. Currently the most developed systems are steam reforming and the partial oxidation with methane, methanol or gasoline as the fuels, but in both of these cases, the CO level in the product gas stream is typically 50 to 100 ppm.

Carbon monoxide is a major problem because trace amounts of CO in the H₂ feed gas; more than 10 ppm of CO will poison the Pt anode electrocatalyst in the state-of-the-art PEMFCs operating at 80° C. CO-tolerant electrocatalysts (such as Pt—Mo, Pt—Ru) have been investigated, but problems still exist with these electrocatalysts including a 5 to 10 times higher Pt loading than required for pure platinum catalysts, a maximum CO tolerance of ˜50 ppm, and an increased overpotential for the anodic reaction in the presence of low level CO. An alternate approach to gain CO tolerance is to take advantage of the fact that the free energy of adsorption of carbon monoxide on Pt has a larger positive temperature dependence than that of H₂. Therefore, at elevated temperatures H₂ adsorption on Pt becomes competitive with CO adsorption, and CO tolerance levels. Increase. See FIG. 1. A quantitative analysis of the free energy for the H₂ and CO adsorption as a function of temperature suggests that by elevating the operating temperature of the cell, for example up to 145° C., CO tolerance at the anode should increase by a factor of ˜20 (from 5-10 ppm to 100-200 ppm). This effect has been shown experimentally in commercialized phosphoric acid fuel cell power plants. Cells of this type operating at 200° C., demonstrate a CO tolerance of about 1%.

Other difficulties, encountered with PEMFCs, are the elaborate water and thermal management sub-systems needed to achieve optimal performance and maintain ideal operating temperatures. By elevating the temperature of the fuel cell stack, thermal management can be simplified due to more efficient waste heat rejection. However, current PEMFCs utilize sulfonated perfluoropolymer membranes and the ability of this type of proton exchange membrane to conduct protons is proportional to its extent of hydration. Presently, reactant gases need to be humidified before entering the cell to avoid drying out the membrane. Membrane dehydration also causes the membrane to shrink, reducing the contact between the electrode and membrane, and may also introduce pinholes leading to the crossover of the reactant gases. Thus, the concept of operating a cell at higher temperatures to alleviate the CO poisoning problem introduces another dilemma; keeping the membrane hydrated in order to maintain proton conductivity and its mechanical properties.

It has been demonstrated that by lowering the equivalent weight (i.e. grams of polymer per mole of sulfonate groups) and decreasing the thickness of the membrane, fuel cell performance improves due to decreased membrane resistivity and that incorporating hydroscopic particles can reduce water loss from Nafion. Although improved membrane water retention at normal operating temperatures has been demonstrated, no elevated temperature H₂/O₂ PEMFC experiments above 100° C. have been reported.

### SUMMARY OF THE INVENTION

Improved hydrogen/oxygen proton-exchange membrane fuel cells use a novel composite membrane which allows the fuel cell to operate at higher temperatures with significantly improved carbon monoxide-tolerance. The composite membranes are comprised of a perfluorosulfonic acid with an incorporated dopant. The fuel cells have carbon-monoxide tolerances greater than 500 parts per million in the gas fuel stream. These composite membranes can be produced by impregnating a liquid dopant directly into a pre-formed perfluorosulfonic acid membrane or by mixing a liquid perfluorosulfonic acid with dopant particles in a solvent and evaporating the solvent.

### BRIEF DESCRIPTION OF THE DRAWINGS

FIG. 1 is a cyclic voltammograms comparing the unmodified Nafion 115 and Nafion 115/silicon oxide membranes.

FIG. 2 is a graph comparing the electrical performance of various unmodified PFSAs when operated at single cell temperatures of 80° C. and 130° C.

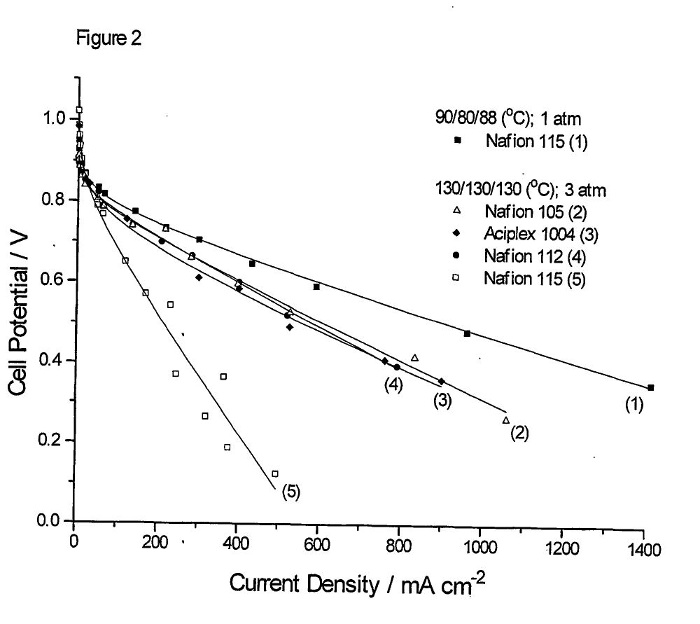

FIG. 3 is a graph comparing the electrical performance of various unmodified PFSAs when operated at single cell temperatures of 80° C. and 130° C.

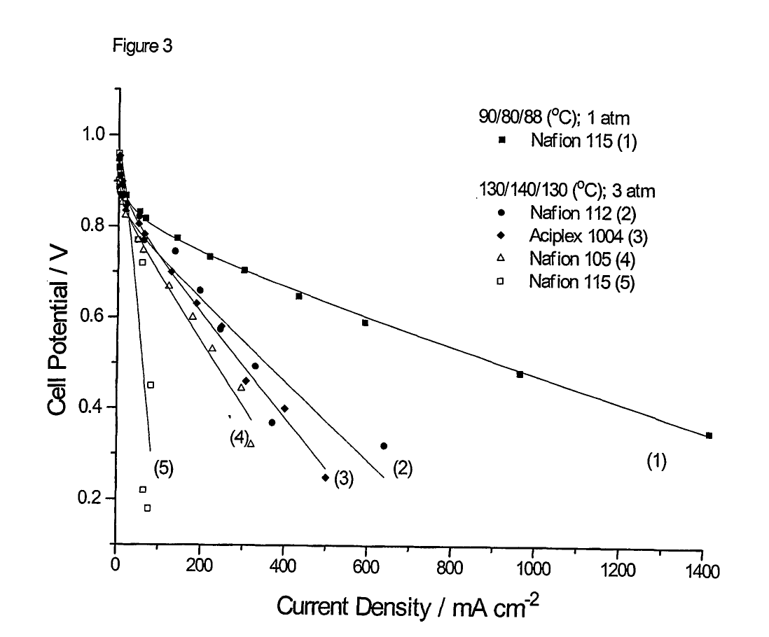

FIG. 4 is a graph comparing the electrical performance of various composite silicon oxide/PFSAs when operated at single cell temperatures of 130° C.

FIG. 5 is a graph comparing the electrical performance of various composite silicon oxide/PFSAs when operated at single cell temperatures of 130° C.

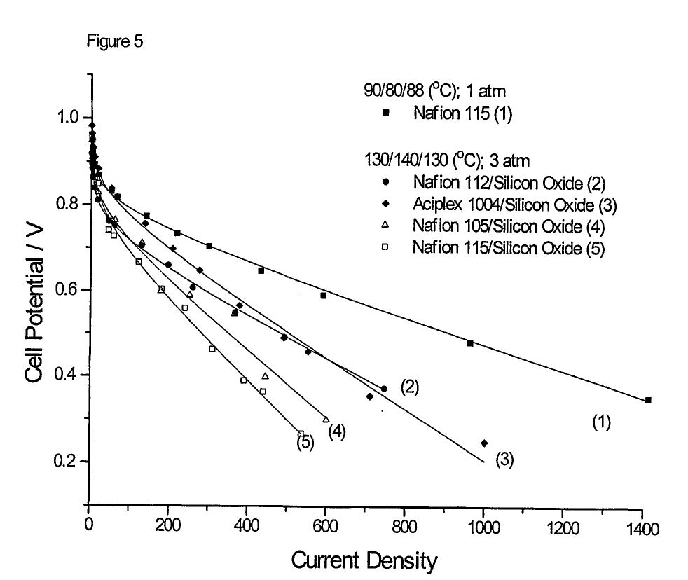

FIG. 6 is a graph comparing the electrical performance of various composite zeolite/PFSAs when operated at a single cell temperature of 130° C.

FIG. 7 is a graph comparing the electrical performance of a ZSM-5 zeolite/PFSA when operated at a single cell temperature of 130° C.

FIG. 8 is a graph comparing the electrical performance of a composite diatomaceous earth/PFSA when operated at a single cell temperature of 130° C.

FIG. 9 is a graph comparing the CO-tolerance and electrical performance of a composite titania/PFSA when operated at a single cell temperature of 130° C. with an unmodified PSFA.

### DESCRIPTION OF PREFERRED EMBODIMENTS

It has been discovered that by incorporating various dopants into a PSFA membrane the membrane could be used as a proton exchange membrane in an H₂/O₂ fuel cell at temperatures above 100° C., as high as at least 145° C. and will exhibit superior current density and prolonged, carbon monoxide tolerance two orders of magnitude higher than current PSFA membranes operating at the standard 80° C.

Any PFSAs are suitable for use in the doped membranes and include those commercially available as Nafion (Dupont Chemical) and Aciplex (Asahi Chemical Inc.). The dopants are introduced either by impregnation into an existing PSFA membrane or by recasting a membrane from solubilized PSFA and dopant. Impregnation can be accomplished using existing PSFA membranes such as, Nafion 105, Nafion 112, Nafion 115, and Aciplex 1004, for example. The membrane is pre-treated/cleansed and then immersed in solution containing the dopant or a dopant precursor, for example, tetraethoxysilane.

Dopants suitable to be incorporated via recasting include, but are not limited to, for example: siloxane polymer, silica, titania, alumina, zeolite such as ZSM-5 (ExxonMobil), 4A (e.g., Union Carbide ), Y (e.g., Union Carbide), A (e.g., Union Carbide), and N (e.g., Union Carbide), and diatomaceous earth.

Recast membranes are prepared by mixing a PSFA solution, such as Nafion or Aciplex, in an organic solvent, such as an alcohol, with a solution of the desired dopant and then drying the mixture to form a membrane. The synthesis involves taking the ‘solubilized’ form of the perfluorinated sulfonic acid polymer (PPSA—a commercially available material), diluting it with an organic solvent such as isopropanol to adjust viscosity and then adding the desired inorganic component, i.e., dopant, as a well-dispersed powder. The powder is suspended in the solvent by mechanical stirring. 1-10% by weight of the powder dopant component is added. The solvent is then allowed to evaporate or heated forming a membrane. The membrane is then treated with hydrogen peroxide solution then, mineral acid washings, followed by extensive washing with water.

The morphology and surface treatment of the dopant/inorganic material is to be important. Particle size, particle surface area, and the functional groups on the surface of the particle can all effect the final product. Particles ranging in size from ˜10 nm to ˜200 μm. Surface areas from 10's of cm2/g to ˜1000 cm2/g have been studied. In general, the best performance is associated with the smaller particles (and higher surface areas). Organic materials must be carefully removed from the dopant particles prior to reaction. The dopant powders should be pre-treated either by using a set of organic decreasing solvents and/or treatment with a mineral acid.

The invention can be further illustrated by the following examples. These examples are provided for illustration purposes and are not limiting of the scope of the invention.

### EXAMPLE 1

Preformed PFSAs (Aciplex 1004 [Asahi Chemical Inc.], Nafion 115, Nafion 112, Nafion 105 [Du Pont Chemical]) were pre-treated by refluxing in a 50:50 mixture (by volume) of water and concentrated HNO₃ (70.8% HNO₃, Fisher) for 6-8 hours, followed by a 50:50 mixture (by volume) of water and concentrated H₂SO₄ (95-98% H₂SO₄, Fisher) for 6-8 hours to remove trace metal impurities. The membranes were then refluxed in dionized H₂O until the pH of the H₂O was equal to or greater than 6.5 indicating that all excess acid was removed from the membrane. After the membranes were dried for 24 hours in a vacuum oven at 100° C.

### EXAMPLE 2

The membranes from Example 1 were immersed in a 2:1 mixture (by volume) of methanol/H₂O for 5 minutes followed by immersion in a 3:2 mixture (by volume) of tetraethoxysilane (98% TEOS, Aldrich)/methanol for varied amounts of time. The duration of time varied according to the desired percent weight of silicon oxide and which membrane was used. After the treatment, the membrane was placed in a vacuum oven at 100° C. for 24 hours. The composite membranes were then refluxed in 3% by volume H₂O₂ for 1 hour to remove organic impurities, two times in dionized H₂O for 1 hour, in 0.5M H₂SO₄ for 1 hour and two times in dionized H₂O for 1 hour.

### EXAMPLE 3

Recast PFSA/silicon oxide membranes were prepared by mixing 5% commercial PFSA solution (Nafion [Dupont Chemical] or Aciplex [Asahi Chemical Inc.]) with double its volume of isopropyl alcohol and varying amounts of a siloxane polymer solution sufficient to produce a silicon oxide content in the membrane of up to about 10 wt %. The siloxane polymer solution was prepared by mixing 2 ml of TEOS, 4.7 ml of dionized H₂O and 100 μl 0.1M HCl for 3 hours at room temperature. The PFSA, isopropyl alcohol and siloxane polymer solution was then placed in an oven at 90° C. overnight. After the recast membranes were formed, they were post-treated in the same manner as the preformed PFSA/silicon oxide membranes.

### EXAMPLE 4

The method of Example 3 was followed using Aciplex [Asahi Chemical Inc.] as the PSFA source.

Electron microprobe (CAMECA SX-50) analysis was used to obtain the distribution of Si and O over the cross-section of the composite membranes from Examples 2, 3 and 4. Fourier Transform Infrared Spectroscopy—Attenuated Total Reflectance (FTIR-ATR) spectra were obtained using a BioRad spectrometer (resolution=2 cm₋₁). A ZnSe crystal was used as the ATR plate with an angle of incidence of 45°.

### EXAMPLE 5

Pt/C fuel electrodes (ETEK Inc.) with a Pt loading of 0.4 mg/cm², were impregnated with 0.6 mg/cm² of PFSA (dry weight) by applying 12 mg/cm² of 5% PFSA solution with a brush. The electrode area was 5 cm². The membrane electrode assembly (MEA) was prepared by heating the electrode/membrane/electrode sandwich (active area of electrode was 5 cm²) to 90° C. for 1 minute in a Carver Hot-Press with no applied pressure, followed by increasing the temperature to 130° C. for 1 minute with no applied pressure and finally hot-pressing the MEA at 130° C. and 2 MPa for 1 minute. The MEA was positioned in a single cell test fixture, which was then installed in the fuel cell test station (Globetech Inc., GT-1000). The test station was equipped for the temperature-controlled humidification of the reactant gases (H₂, O₂ and air) and for the temperature control of the single cell. Flow rates of the gases were controlled using mass flow controllers. The total pressure of the gases was controlled using back-pressure regulators.

### EXAMPLE 6

The single cells of Example 5 were fed with humidified H₂ and O₂ at atmospheric pressure (reactant gas and water vapor pressure equal to 1 atm) and the temperature of the H₂ and O₂ humidifiers and of the single cell was raised slowly to 90° C., 88° C. and 80° C. respectively. During this period, the potential of the single cell was maintained at a constant value of 0.4 V, to reach an optimal hydration of the membrane using the water produced in the cell. After a single cell had reached steady-state conditions (i.e. current density remained constant over time at a fixed potential), cyclic votammograms were recorded at a sweep range of 20 mV s⁻¹ in the range of 0.1 V to 1 V vs. RHE for one hour, in order to determine the electrochemically active surface area. Cell potential vs. current density measurements were then made under the desired conditions of temperature and pressure in the PEMFC. Identical procedures were followed for all PFSAs. All the above PEMFC experiments were carried out for all PFSAs (of Examples 2 and 3) at the cell temperatures of 80° C., 130° C. and 140° C. with the total pressure (reactant gas plus water vapor pressure) at 1 or 3 atm. The total cell pressure was varied so that the partial pressures of the reacting gases (O₂ and H₂) were maintained approximately constant independent of temperature. The flow rates of gases were two times stoichiometric. Similar experiments were performed for Air as the oxygen source. The electrode kinetic parameters for all of the PFSAs of Examples 2, 3, and 4 are presented in Table 1.

TABLE 1
Electrode-kinetic parameters for PEMFCs with control and test membranes

| | | | | | | | Current | |
|---|---|---|---|---|---|---|---|---|
| | Temperature | | | | | | Density | |
| | (° C.) | Pressure | Eₒ | b | iₒ | R | (mA cm⁻²) | |
| Membrane | H₂/cell/O₂ | (atm) | (mV) | (mV/dec) | (mA/cm²) | (Ωcm²) | at .9 V | at 0.4 V |

a) Hydrogen and Oxygen used as fuels

| | | | | | | | | |
|---|---|---|---|---|---|---|---|---|
| Control | 90/80/88 | 1/1 | 991 | 43 | 4.0 E−6 | 0.28 | 6 | 1275 |
| Nafion | | | | | | | | |
| 115 | | | | | | | | |
| | 130/130/130 | ″ | 1000 | 93 | 2.4 E−3 | 1.3 | 8 | 280 |
| Control | 130/140/130 | ″ | 937 | 87 | 4.3 E−4 | 2.1 | 8 | 200 |
| Nafion | | | | | | | | |
| 115 | | | | | | | | |
| Control | 130/130/130 | ″ | 910 | 43 | 5.2 E−8 | 0.5 | 1 | 770 |
| Recast | | | | | | | | |
| Nafion | | | | | | | | |
| Control | 130/140/130 | ″ | 900 | 42 | 3.1 E−8 | 2.4 | — | 207 |
| Recast | | | | | | | | |
| Nafion | | | | | | | | |
| Control | 130/130/130 | ″ | 904 | 41 | 1.20 E−8 | 0.5 | 2 | 765 |
| Nafion | | | | | | | | |
| 112 | | | | | | | | |
| Control | 130/140/130 | ″ | 898 | 41 | 8.45 E−9 | 0.83 | — | 465 |
| Nafion | | | | | | | | |
| 112 | | | | | | | | |
| Control | 130/130/130 | ″ | 914 | 50 | 5.10 E−7 | 0.45 | 2 | 815 |
| Nafion | | | | | | | | |
| 105 | | | | | | | | |
| Control | 130/140/130 | ″ | 904 | 38 | 2.8 E−9 | 1.4 | 2 | 300 |
| Nafion | | | | | | | | |
| 105 | | | | | | | | |
| Control | 130/130/130 | ″ | 989 | 69 | 3.3 E−4 | 0.4 | 9 | 775 |
| Aciplex | | | | | | | | |
| 1004 | | | | | | | | |
| Control | 130/140/130 | ″ | 961 | 62 | 4.76 E−5 | 1.0 | 7 | 380 |
| Aciplex | | | | | | | | |
| 1004 | | | | | | | | |
| Control | 130/130/130 | ″ | 934 | 61 | 1.46 E−5 | 0.4 | 5 | 885 |
| Recast | | | | | | | | |
| Aciplex | | | | | | | | |
| Control | 130/140/130 | ″ | 944 | 66 | 4.80 E−5 | 0.98 | 2.5 | 380 |
| Recast | | | | | | | | |
| Aciplex | | | | | | | | |
| Nafion | 130/130/130 | ″ | 932 | 92 | 6.9 E−4 | 0.36 | 8.3 | 848 |
| 115/silicon | | | | | | | | |
| oxide (6%) | | | | | | | | |
| Nafion | 130/140/130 | ″ | 930 | 96 | 8.7 E−4 | 0.81 | 8.1 | 389 |
| 115/silicon | | | | | | | | |
| oxide (6%) | | | | | | | | |
| Recast | 130/130/130 | ″ | 932 | 72 | 9.1 E−5 | 0.33 | 4 | 969 |
| Nafion/silicon | | | | | | | | |
| oxide (10%) | | | | | | | | |
| Recast | 130/140/130 | ″ | 931 | 61 | 1.6 E−5 | 0.78 | 3 | 471 |
| Nafion/silicon | | | | | | | | |
| oxide (10%) | | | | | | | | |
| Nafiion | 130/130/130 | ″ | 918 | 67 | 2.28 E−5 | 0.22 | 2 | 1395 |
| 112/silicon | | | | | | | | |
| oxide (6%) | | | | | | | | |
| Nafiion | 130/140/130 | ″ | 904 | 71 | 2.64 E−5 | 0.44 | 3 | 685 |
| 112/silicon | | | | | | | | |
| oxide (6%) | | | | | | | | |
| Nafion | 130/130/130 | ″ | 931 | 76 | 1.20 E−4 | 0.36 | 4 | 1145 |
| 105/silicon | | | | | | | | |
| oxide (6%) | | | | | | | | |
| Nafion | 130/140/130 | ″ | 935 | 73 | 9.39 E−5 | 0.71 | 3 | 475 |
| 105/silicon | | | | | | | | |
| oxide (6%) | | | | | | | | |
| Aciplex | 130/130/130 | ″ | 975 | 66 | 1.42 E−4 | 0.21 | 8 | 1725 |
| 1004/silicon | | | | | | | | |
| oxide (6%) | | | | | | | | |
| Aciplex | 130/140/130 | ″ | 976 | 73 | 3.42 E−4 | 0.55 | 7 | 675 |
| 1004/silicon | | | | | | | | |
| oxide (6%) | | | | | | | | |
| Recast | 130/130/130 | ″ | 918 | 70 | 3.61 E−5 | 0.28 | 6 | 1090 |
| Aciplex/ | | | | | | | | |
| silicon | | | | | | | | |
| oxide | | | | | | | | |
| (10%) | | | | | | | | |
| Recast | 130/140/130 | ″ | 906 | 70 | 2.43 E−5 | 0.63 | — | 505 |
| Aciplex/ | | | | | | | | |
| silicon | | | | | | | | |
| oxide | | | | | | | | |
| (10%) | | | | | | | | |

b) Hydrogen and Air used as fuels

| | | | | | | | | |
|---|---|---|---|---|---|---|---|---|
| Control | 130/130/130 | 3/3 | 888 | 61 | 2.57 E−6 | 1.59 | — | 217 |
| Nafion | | | | | | | | |
| 115 | | | | | | | | |
| Control | 130/140/130 | ″ | 885 | 47 | 4.80 E−6 | 2.62 | — | 145 |
| Nafion | | | | | | | | |
| 115 | | | | | | | | |
| Control | 130/130/130 | ″ | 861 | 58 | 4.52 E−7 | 1.27 | — | 335 |
| Recast | | | | | | | | |
| Nafion | | | | | | | | |
| Control | 130/140/130 | ″ | 855 | 61 | 7.39 E−7 | 3.15 | — | 140 |
| Recast | | | | | | | | |
| Nafion | | | | | | | | |
| Control | 130/130/130 | ″ | 882 | 33 | 3.05 E−11 | 0.96 | — | 410 |
| Nafion | | | | | | | | |
| 112 | | | | | | | | |
| Control | 130/140/130 | ″ | 874 | 45 | 1.29 E−8 | 1.65 | — | 222 |
| Nafion | | | | | | | | |
| 112 | | | | | | | | |
| Control | 130/130/130 | ″ | 906 | 42 | 2.04 E−9 | 0.98 | 1 | 407 |
| Nafion | | | | | | | | |
| 105 | | | | | | | | |
| Control | 130/140/130 | ″ | 892 | 47 | 6.76 E−8 | 2.18 | — | 177 |
| Nafion | | | | | | | | |
| 105 | | | | | | | | |
| Control | 130/130/130 | ″ | 887 | 33 | 4.33 E−11 | 0.99 | — | 430 |
| Aciplex | | | | | | | | |
| 1004 | | | | | | | | |
| Control | 130/140/130 | ″ | 892 | 31 | 1.34 E−11 | 2.05 | — | 200 |
| Aciplex | | | | | | | | |
| 1004 | | | | | | | | |
| Nafion | 130/130/130 | ″ | 896 | 49 | 1.60 E−7 | 0.78 | — | 465 |
| 115/silicon | | | | | | | | |
| oxide (6%) | | | | | | | | |
| Nafion | 130/140/130 | ″ | 892 | 38 | 1.35 E−9 | 1.91 | — | 210 |
| 115/silicon | | | | | | | | |
| oxide (6%) | | | | | | | | |
| Recast | 130/130/130 | ″ | 918 | 37 | 3.93 E−9 | 0.73 | 3 | 570 |
| Nafion/silicon | | | | | | | | |
| oxide (10%) | | | | | | | | |
| Recast | 130/140/130 | ″ | 864 | 53 | 1.30 E−7 | 2.0 | — | 170 |
| Nafion/silicon | | | | | | | | |
| oxide (10%) | | | | | | | | |
| Nafiion | 130/130/130 | ″ | 887 | 45 | 2.51 E−8 | 0.53 | — | 670 |
| 112/silicon | | | | | | | | |
| oxide (6%) | | | | | | | | |
| Nafiion | 130/140/130 | ″ | 884 | 57 | 8.86 E−7 | 0.73 | — | 445 |
| 112/silicon | | | | | | | | |
| oxide (6%) | | | | | | | | |
| Nafion | 130/130/130 | ″ | 900 | 58 | 2.13 E−6 | 0.61 | — | 565 |
| 105/silicon | | | | | | | | |
| oxide (6%) | | | | | | | | |
| Nafion | 130/140/130 | ″ | 898 | 58 | 1.96 E−6 | 1.3 | — | 275 |
| 105/silicon | | | | | | | | |
| oxide (6%) | | | | | | | | |
| Aciplex | 130/130/130 | ″ | 932 | 49 | 8.68 E−7 | 0.52 | 3 | 780 |
| 1004/silicon | | | | | | | | |
| oxide (6%) | | | | | | | | |
| Aciplex | 130/140/130 | ″ | 906 | 43 | 3.07 E−8 | 1.4 | — | 317 |
| 1004/silicon | | | | | | | | |
| oxide (6%) | | | | | | | | |

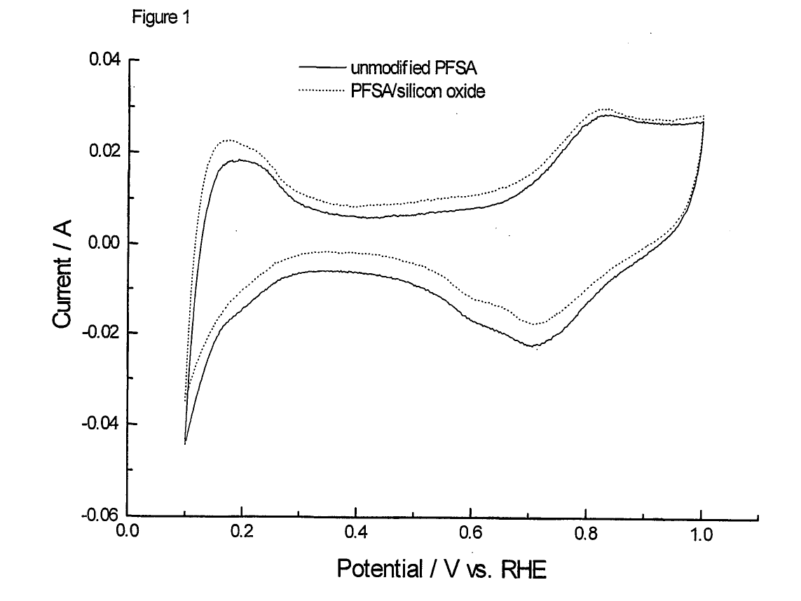

Typical cyclic voltammograms for the cathode in the presence of 1 atm H₂ with the unmodified Nafion 115 and Nafion 115/silicon oxide membranes are shown in FIG. 1 of the anodic peak at 0.1 V vs. RHE(H₂→2H⁺+2e).

Despite the variations of the PFSAs physical and chemical makeup, the resistivities of the PFSAs are still all higher than Nafion 115 when operated at 80° C. and 1 atm of pressure. This is not the case when the PFSAs are doped with silicon oxide.

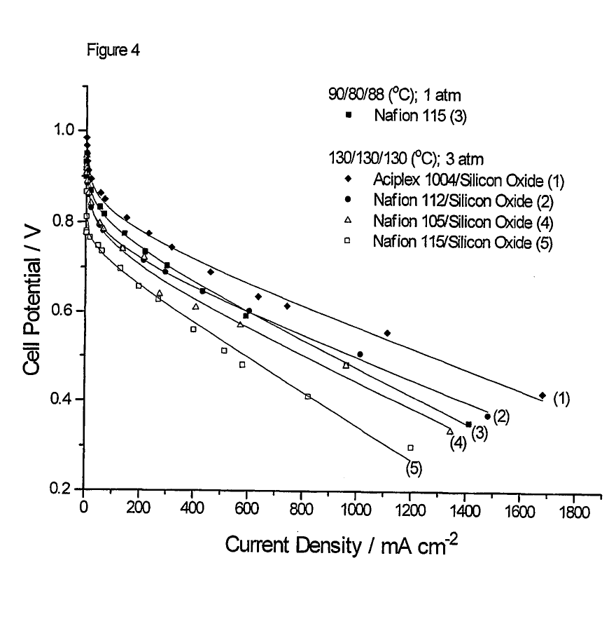

FIG. 4 shows the polarization curves of various doped PFSAs at a single cell temperature of 130° C., with prehumidified reactant gases at 130° C. and a pressure of 3 atm. As in the other polarization curves, the comparison standard is unmodified Nafion 115 shown at a single cell temperature of 80° C. with the hydrogen-oxygen prehumidified gases at 90° C. and 88° C. respectively and a pressure of 1 atm. In all cases, the PFSA/silicon oxide composite membrane shows resistivities 50% lower than their respective unmodified PFSAs under the same operating conditions.

When air is substituted for pure oxygen (table 1) as the reactant gas at the cathode, current densities decrease by a factor of ˜20-50% for both the modified and unmodified Nafion membranes under all test conditions. A theoretical decrease of ˜80% is expected under stoichiometric conditions. However, the use of 2 times stoichiometric flow minimizes this effect.

### EXAMPLE 7

Recast PFSA silicon oxide membranes were prepared by mixing 5% commercial PFSA solution (Nafion [Dupont Chemical] with double its volume of isopropyl alcohol and varying amounts of a suspended dopant powder (silicon dioxide). The PFSA, isopropyl alcohol and metal oxide suspension was then placed in an oven at 90° C. overnight. The composite membranes were then refluxed in 3% by volume H₂O₂ for 1 hour to remove organic impurities, two times in dionized H₂O for 1 hour, in 0.5M H₂SO4 for 1 hour and two times in dionized H₂O for 1 hour.

### EXAMPLE 8

The method of Example 7 was followed using ZSM-5 zeolite (ExxonMobil) as the dopant.

### EXAMPLE 9

The method of Example 7 was followed using titania as the dopant.

### EXAMPLE 10

The method of Example 7 was followed using 4A zeolite (Union Carbide) as the dopant.

### EXAMPLE 11

The method of Example 7 was followed using Y zeolite (Union Carbide) as the dopant.

### EXAMPLE 12

The method of Example 7 was followed using A zeolite (Union Carbide) as the dopant.

### EXAMPLE 13

The method of Example 7 was followed using N zeolite (Union Carbide) as the dopant.

### EXAMPLE 14

The method of Example YY was followed using diatomaceous earth as the dopant.

### EXAMPLES 15-22

The method of Examples 7-14 was followed using Aciplex [Asahi Chemical Inc.] as the PSFA source.

### EXAMPLE 23

A time performance test in which the cell current was monitored at a cell voltage of 0.65V was performed on the control Nafion 115 and the Nafion 115, Nafion 112 and Aciplex 1004 composite membranes. The control Nafion 115 membrane's performance fell dramatically and within an hour no current was observed, while after 50 hours of continuous operation at 0.65 V, the current output of the composite membrane remained unchanged indicating that the membrane's hydration was not transitional.

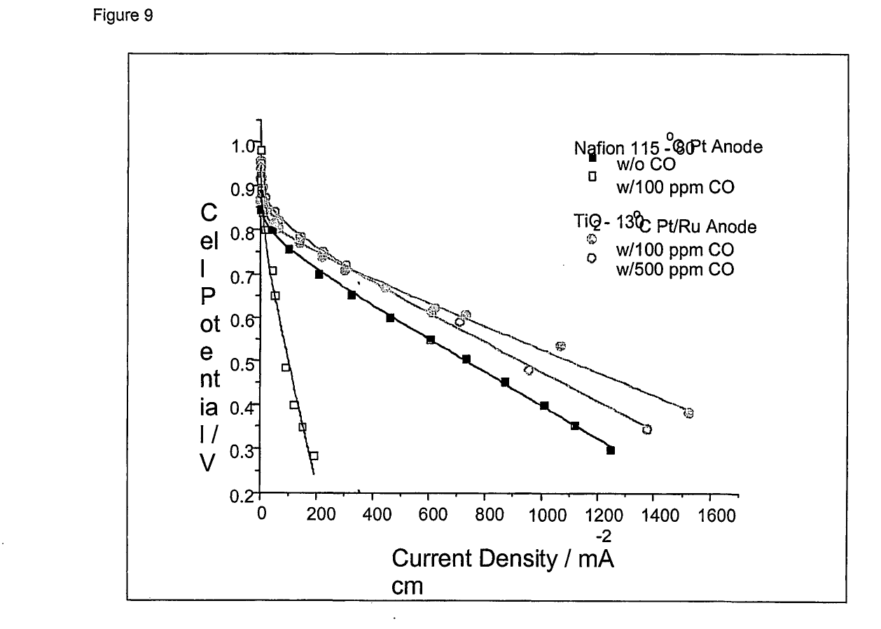

Composite membranes of the present invention exhibit carbon monoxide-tolerance up to at least 500 ppm in the gas stream. The following Experiment and graph of FIG. 9 illustrates current-voltage curves comparing the effects of carbon monoxide on a standard Nafion PEMFC and a high temperature composite membrane cell (HT-PEMFC) of the present invention incorporating a titania dopant. The open and closed square curves show the response of a standard Nafion 115 PEMPC utilizing commercial platinum catalyzed electrodes (E-Tek) to 100 ppm of CO in the hydrogen stream. The cell was run with humidified hydrogen and oxygen at 80° C., and with one atmosphere of total pressure. The solid squares represent the control response of the Nafion 115 cell in the absence of CO, while the open squares show the degradation of the cell response after a several hour purge with hydrogen doped with 100 ppm CO.

The open and closed point curves show the response of the high temperature cell to 100 (solid points) and 500 ppm (open points) of CO in the hydrogen feed. The HT-PEMFC is slightly degraded compared to data taken in the absence of CO (not shown) however, shows a response that is superior to the standard Nafion cell in the absence of CO. The HT-PEMFC shown here is composed of a titania/Nafion composite membrane, a commercial platinum catalyzed cathode, and a commercial (CO resistant) Pt/Ru anode. Utilizing such an anode with the standard Nafion cell would improve the cell somewhat, However, the response would still be far inferior to the demonstrated response of the HT-PEMFC. The HT-PEMFC was run at a total pressure of 3 atm (humidified hydrogen and oxygen) and a temperature of 130° C. Under these conditions the partial pressures of hydrogen and oxygen in the standard Nafion cell and the HT-PEMFC are similar (˜0.5 atm per gas).

All cells were purged with carbon monoxide doped hydrogen for several hours prior to collecting the data shown. The points represent the experimentally obtained data, while the solid lines are fits to equations representing the fundamental parameters associated with fuel cell dynamics.

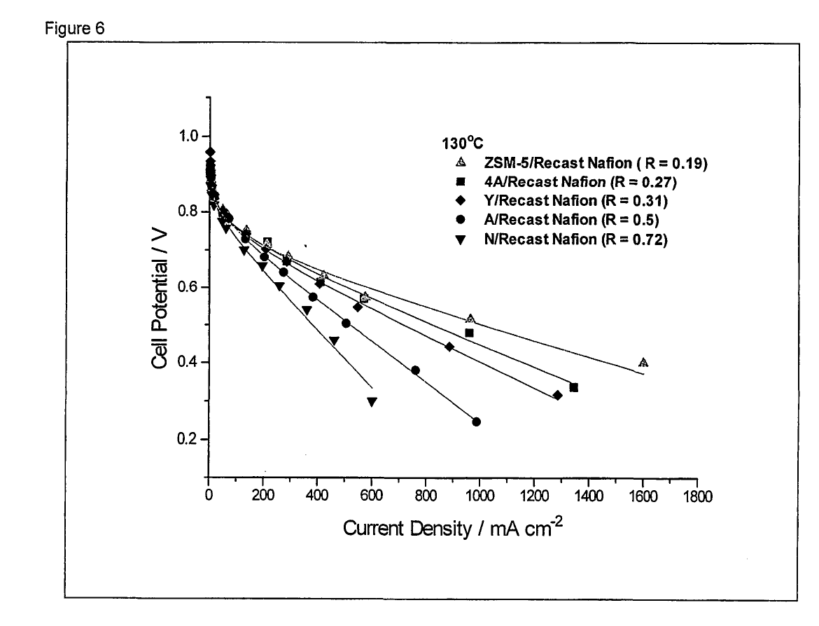

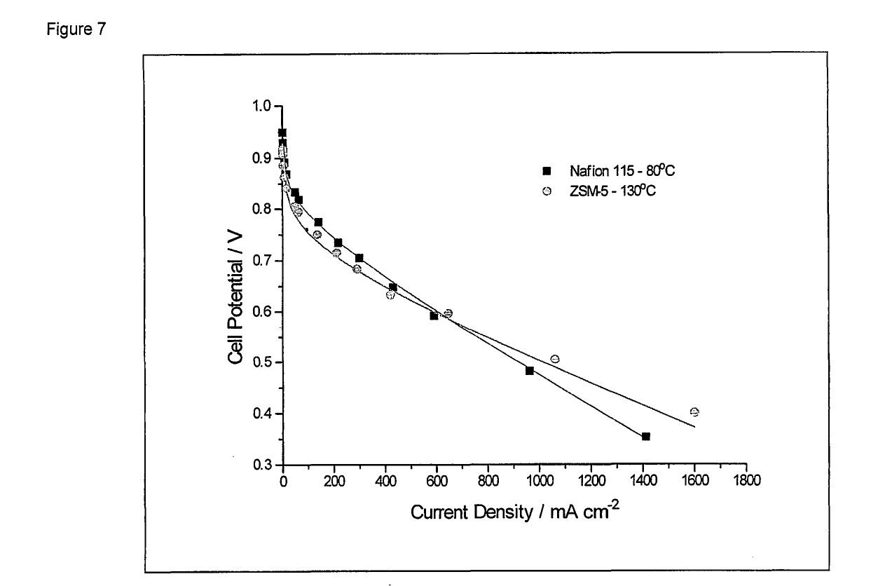

FIGS. 6 and 7 show the current-voltage response for a series of Nafion/Zeolite composite membranes. The ZSM-5 composite exhibits the best results of the zeolite dopants. All cells were run at 130° C. with humidified hydrogen and oxygen gases. A total gas pressure of 3 atm was maintained (˜0.5 atm partial pressure of reactive gases). The cell utilized commercial Pt on carbon electrodes (E-Tek) in a 5 cm² format. The R values are calculated cell resistances. The top two curves (ZSM-5 and 4A) represent results that are better than a simple Nafion cell run at 80° C. Hydrogen/air results are comparable to the data presented here.

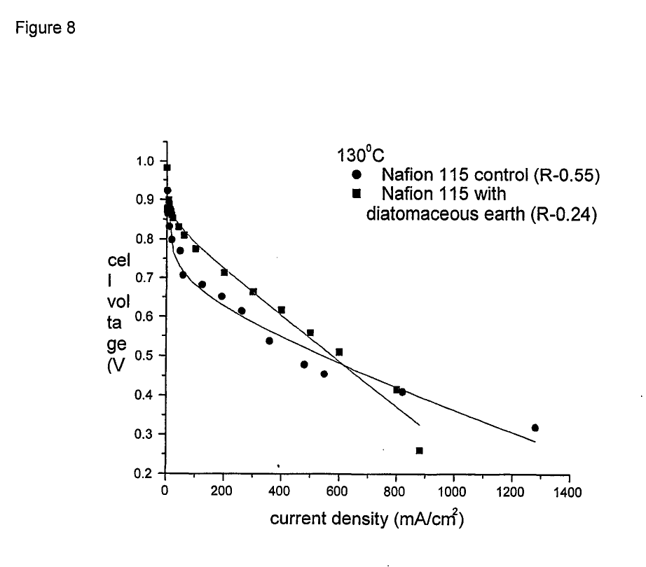

FIG. 8 shows the current-voltage response for Nafion/Diatomaceous Earth composite membrane fuel cell. Recast Nafion membrane containing Diatomaceous Earth and operated at 130° C. is compared to a standard Nafion 115 based cell operating at 80° C. Both cells use commercial Pt on carbon electrodes. Both cells have reactive hydrogen and oxygen partial pressures of ˜0.5 atm. The high temperature cell has a total pressure of 3 atm. Both cells use fully humidified gases. The R values are the total cell resistance, extracted from the solid line fit of the data points to the theoretical model of cell operation.

1. A composite proton exchange membrane comprised of perfluorosulfonic acid and a dopant, wherein said membrane has a carbon monoxide tolerance above 100 ppm at a temperature above about 130° C.

2. The composite membrane of claim 1 wherein said membrane has a carbon monoxide tolerance of at least 500 ppm.

3. The composite membrane of claim 1 wherein said dopant is selected from the group consisting of zeolites, diatomaceous earth, oxides of titanium, silicon, and aluminum, and mixtures thereof.

4. The composite membrane of claim 1 wherein said dopant is selected from the group consisting of titanium dioxide, silicon dioxide, alumino silicates, silicon tetraoxide, alumina tetraoxide, silicon oxide polymer and mixtures thereof.

5. The composite membrane of claim 1 wherein said dopant is comprised of diatomaceous earth.

6. The composite membrane of claim 1 wherein said dopant is comprised of titania.

7. The composite membrane of claim 1 wherein said one or more oxides are comprised of a zeolite.

8. The composite membrane of claim 7 wherein said one or more oxides are comprised of a zeolite selected from the group consisting of ZSM-5, 4A, Y, A, and N.

9. The composite membrane of claim 8 wherein said one or more oxides are comprised of ZSM-5 zeolite.

10. A method for producing a composite proton exchange film comprising the steps of:
A) adding a dopant to a solution of perfluorosulfonic acid, and an organic solvent;
B) evaporating said solvent to leave a membrane;
C) rinsing said membrane with one or more solvents.

11. The method of claim 8 wherein said oxide source is selected from the group consisting of diatomaceous earth, zeolite, titania, silica, alumina, and siloxane polymers.

12. A method for producing a composite proton exchange membrane comprising the steps of:
A) immersing a perfluorosulfonic acid membrane in a solution comprised of a silane and a solvent;
B) removing said membrane from said solution;
C) drying said membrane; and
D) treating said membrane with one or more solvents.

13. The method of claim 10 wherein said silane is tetraethoxy silane and said solvent is methanol.

14. A high-temperature, carbon monoxide-tolerant proton exchange membrane fuel cell comprising a platinum cathode, a composite proton exchange membrane comprised of perfluorosulfonic acid and a dopant, and a Pt/Ru anode.

15. The fuel cell of claim 14 wherein said composite membrane has a carbon monoxide tolerance above 100 ppm at a temperature above about 130° C.

16. The fuel cell of claim 14 wherein said composite membrane has a carbon monoxide tolerance of at least 500 ppm.

17. The fuel cell of claim 14 wherein said dopant is selected from the group consisting of zeolites, diatomaceous earth, oxides of titanium, silicon, and aluminum, and mixtures thereof.
